(19) United States
(12) Patent Application Publication
(10) Pub. No.: US 2014/0344444 A1
(43) Pub. Date: Nov. 20, 2014

(54) Recovery of Dynamic Host Configuration Protocol IP Addresses

(71) Applicant: Hangzhou H3C Technologies Co., Ltd., Hangzhou (CN)

(72) Inventors: Wenguo Wu, Beijing (CN); Changfeng Zhao, Beijing (CN); Leifang Li, Beijing (CN)

(73) Assignee: Hangzhou H3C Technologies Co., Ltd., Hangzhou (CN)

(21) Appl. No.: 14/197,190

(22) Filed: Mar. 4, 2014

(30) Foreign Application Priority Data
May 14, 2013 (CN) 201310178714.7

(51) Int. Cl. H04L 29/12

(52) U.S. Cl. CPC H04L 61/2015
USPC 709/224

(57) ABSTRACT

Recovery of an Internet Protocol (IP) address allocated to a client using Dynamic Host Configuration Protocol (DHCP) is provided. Media Access Control (MAC) address and the IP address of the client are stored. When the client is determined as being offline, MAC address and IP address of the client are determined and a DHCP release message carrying the IP address of the client is sent to an address allocation server. The client is determined as being offline based on a shutdown status of a port to which the client is connected. The port may be on the relay device, or an access device that connects the client and the relay device.

### CROSS-REFERENCE TO RELATED APPLICATIONS

This application claims priority to CN Patent Application No. 201310178714.7, filed on May 14, 2013, entitled “Method and Apparatus for Recovering DHCP Client IP Address,” which is incorporated herein by reference.

### BACKGROUND

Dynamic Host Configuration Protocol (DHCP) is used for allocating network configuration parameters, such as Internet Protocol (IP) addresses etc., to a network device. DHCP generally adopts a client/server communication mode and facilitates dynamic configuration of parameters. A client makes a request for configuration parameters to the server, which then responds with configuration parameters allocated for the client.

In general, DHCP provides three IP address allocation strategies, i.e. manual allocation, automatic allocation and dynamic allocation. When dynamic allocation is adopted, allocated IP addresses only have a certain period of validity. Once the time limit expires, the DHCP server may recover the allocated IP addresses.

If a DHCP client wishes to continue using an IP address, it may request for a lease renewal by sending a DHCP request message to the DHCP server. If successful, the DHCP server will respond with a DHCP ACK message, but otherwise, a DHCP NAK message is sent. Lease renewal request may be performed halfway through a lease by unicasting the DHCP request message to the DHCP server. If the initial request fails, the DHCP client may broadcast a DHCP request message, for example at 7/8 of the lease duration to renew the lease.

### BRIEF DESCRIPTION OF DRAWINGS

By way of non-limiting examples, the present disclosure will be described with reference to the following drawings, in which:

FIG. 1 is a flow diagram of a process for recovering IP addresses allocated using DHCP in examples of the present disclosure;

FIG. 2 is a schematic diagram of a network in which a relay device is connected to clients via an access device in examples of the present disclosure;

FIG. 3 is a flow diagram of a process for recovering IP addresses of offline clients in the network in FIG. 2 in examples of the present disclosure;

FIG. 4 is a schematic diagram of a network in which a relay device is directly connected to clients in examples of the present disclosure;

FIG. 5 is a flow diagram of a process for recovering IP addresses of offline clients in the example network in FIG. 4 in examples of the present disclosure;

FIG. 6 is a schematic diagram of a structure of a network device capable of acting as a relay device or access in examples of the present disclosure;

FIG. 7(a) is a schematic diagram of modules of a network device capable of acting as a relay device in FIG. 2 and FIG. 3 in examples of the present disclosure;

FIG. 7(b) is a schematic diagram of modules of a network device capable of acting as a relay device in FIG. 4 and FIG. 5 in examples of the present disclosure; and

FIG. 7(c) is a schematic diagram of modules of a network device capable of acting as an access device in FIG. 2 and FIG. 3 in examples of the present disclosure.

### DETAILED DESCRIPTION

When a client goes offline, the IP address allocated to the client should be recovered by the DHCP server such that it may be allocated to a different client. In this case, the relay device may send a release message carrying the allocated IP address to the DHCP server to release it. To determine whether a client is offline, one conventional approach is polling, where the relay device sends detection messages to the client periodically.

If no response from the client is received within a timeout period, the client is determined as being offline. For example, the detection messages may be Ping, Address Resolution Protocol (ARP) or Internet Control Message Protocol (ICMP) messages etc. Another conventional approach is based on the aging time of ARP table entries. In this case, when an ARP table entry associated with a client is aged out of the ARP table, the relay device determines the client as being offline and sends a release message to the DHCP server to release the IP address allocated to the offline client.

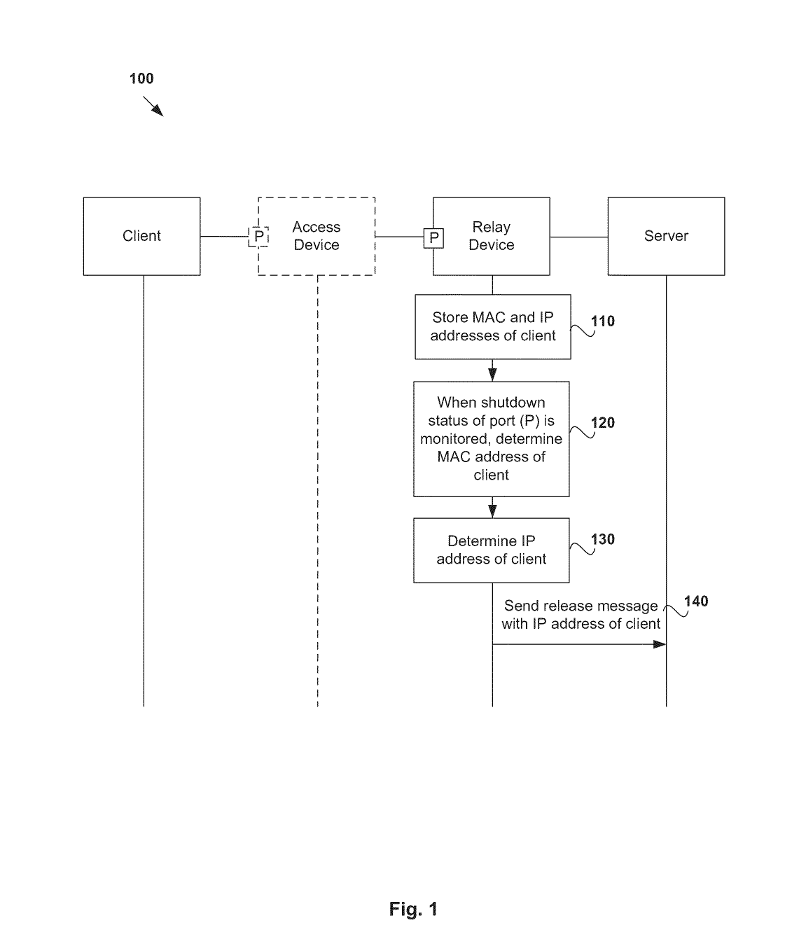

According to examples of the present disclosure and referring to FIG. 1, recovery of an IP address allocated to a client using DHCP may include a relay device performing the following:
At 110, MAC address and IP address of the client are stored.
At 120, when the client is determined as being offline, the MAC address of the client is determined. At 130, the IP address of the client is determined based on the MAC address. At 140, a DHCP release message carrying the IP address of the client is sent to an address allocation server.
The client is determined as being offline based on a shutdown status of a port to which the client is connected. The port may be on the relay device or an access device that connects the client and the relay device. Note that dotted lines in FIG. 1 indicate that the client may be connected to the relay device directly or indirectly via the access device.

According to examples of the present disclosure, a port monitoring approach is used to determine whether a client is offline to recover the allocated IP address. When a shutdown status is detected on the port to which the client is connected, the client is determined as being offline and the relay device sends a release message to the server. The client may be connected to a port on either the relay device (i.e. direct connection), or access device (i.e. indirect connection). The term “access device” refers generally to a network device that connects the client to the relay device, such as an access switch, etc.

Examples of the present disclosure facilitate recovery of IP addresses from offline clients in a timely manner, and reduce load pressure on the relay device. For example, using the port monitoring approach, it is not necessary for the relay device to send detection messages to the clients. Detection messages used in conventional polling approaches are generally sent periodically and consequently there is a time lag between clients going offline and the subsequent detection. As such, using a polling approach, the IP address of the offline client may not be recovered in time for another client, which is especially problematic when there is a shortage of IP addresses.

Also, the detection messages in the polling approach may not be effective because many clients enable a firewall to block these messages and do not respond to them. Further, if there are many clients in the network, there will be many clients that need to be polled and corresponding detection messages (and possible response messages) in the network. By not having to send detection messages, the relay device using a port monitoring approach is relieved from the cost of generating, processing and forwarding these messages as well as managing polling timers for the clients.

Further, using the port monitoring approach according to examples of the present disclosure, offline clients are not detected merely based on aging of ARP table entries. Since aging of ARP table entries may take some time (e.g., a default of 20 minutes, etc.), a client may not be detected as offline efficiently. Aging of ARP table entries may not be an accurate indication that clients have gone offline. For example, if a client does not communicate with other networks for a period of time, its ARP table entry will be aged out of the ARP table although the client is actually online. In this case, the IP address of the client is recovered prematurely.

It will be appreciated that any suitable techniques may be used for port monitoring. One example is to enable an Ethernet Alarm Indication Signal (EAIS) function of Connectivity Fault Detection (CFD) on the relay device or access device. In general, CFD is a VLAN (Virtual Local Area Network)-based end-to-end OAM (Operations, Administration and Maintenance) mechanism on a layer 2 link, and is mainly used for detecting link connectivity, affirming a fault and determining the location where the fault occurs in a layer 2 network. CFD conforms to the CFM (Connectivity Fault Management) protocol of IEEE (Institute of Electrical and Electronics Engineers) 802.1ag and the Y.1731 protocol of ITU-T (International Telecommunication Union Telecommunication Standardization Sector).

It will be appreciated that any suitable technique may be used for storing MAC address and IP address information of clients. For example, when an ARP table entry is newly created locally at a relay device, the new entry is recorded in a separate table known as “client IP address table” or “DHCP client IP address cache table”. The client IP address table may be created when the relay device is started, or when the first entry is created. Since the relay device generally functions as a gateway for the clients, MAC and IP address information of all clients will be eventually stored in the ARP table entry, and as such, the client IP address table.

Alternatively or additionally, DHCP snooping may also be used at the relay device to store MAC address and IP address information of clients. In this case, the relay device monitors and parses DHCP messages to and from the clients to store MAC addresses and dynamically acquired IP addresses of clients. DHCP snooping is generally used by the relay device to generate a security characteristics table based on key fields in the snooped messages.

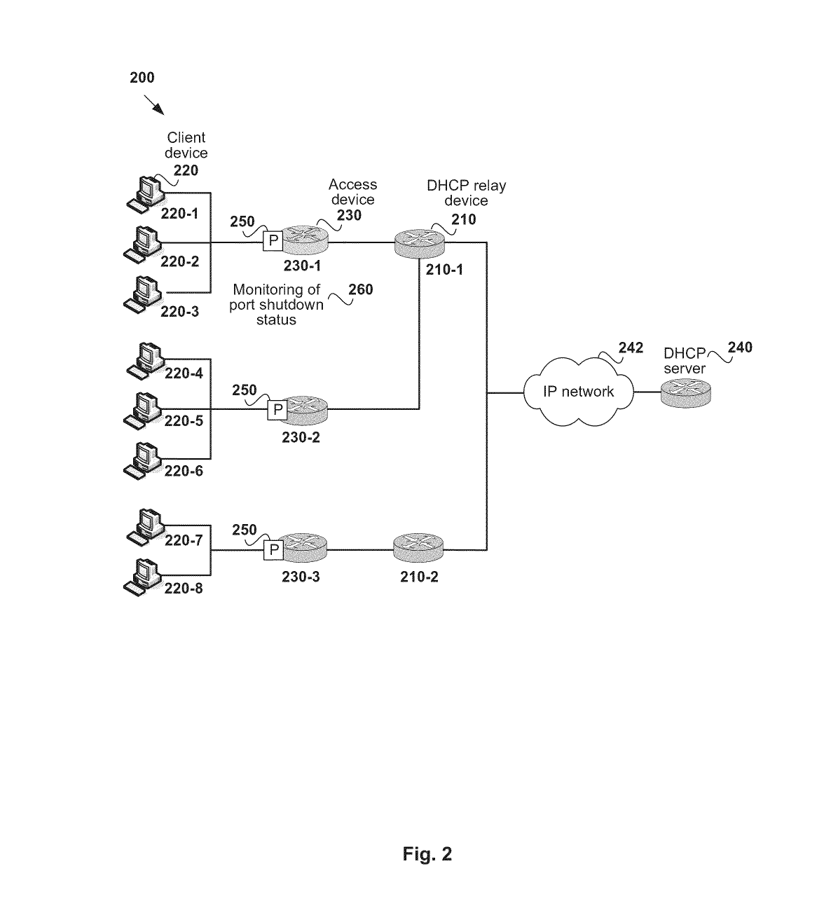

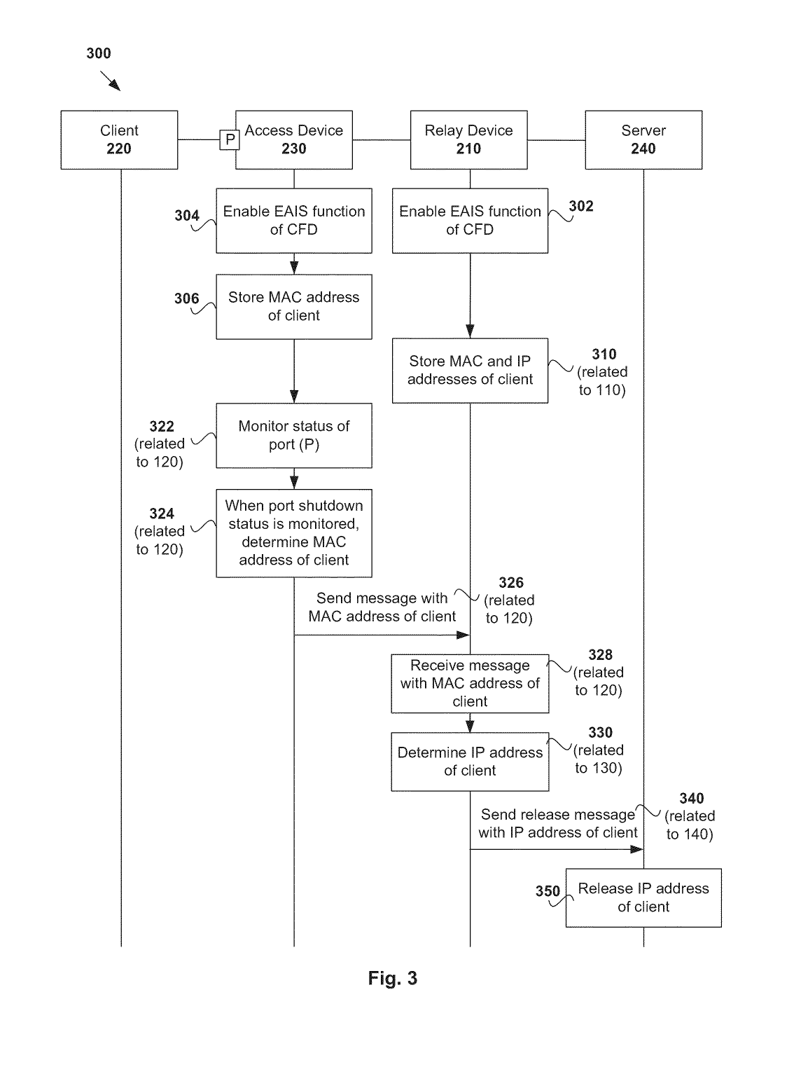

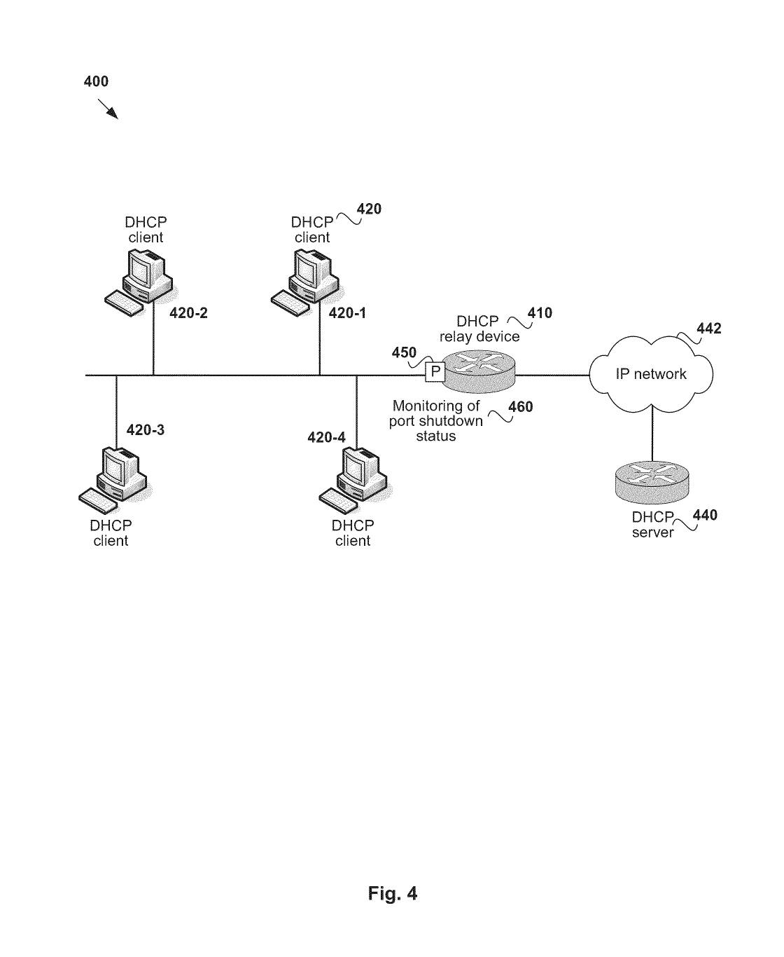

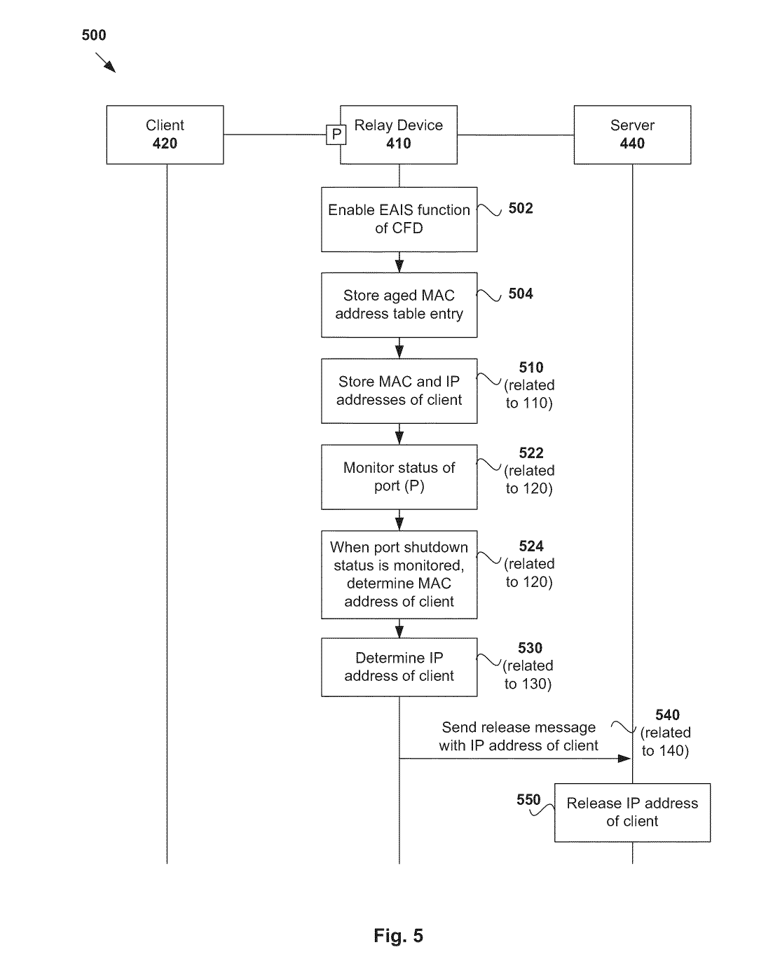

Recovery of IP addresses allocated using DHCP may be performed in any suitable networks that employ DHCP. In practice, there are generally two types of DHCP networks:
FIG. 2 and FIG. 3 illustrate IP address recovery in a network 200 in which relay device 210-1 is connected to DHCP clients 220-1 to 220-6 via access devices 230-1 and 230-2, and relay device 210-2 is connected to DHCP clients 220-7 and 220-8 via access device 230-3 in examples of the present disclosure. Note that relay devices 210-1 and 210-2 are collectively referred to as “relay devices 210” or individually as a generic “relay device 210”, clients 220-1 to 220-8 are collectively as “clients 220” or individually as a generic “client 220”, and access devices 230-1 to 230-3 collectively as “access devices 230” or individually as a generic “access device 230”. Relay device 210 connects clients 220 to DHCP server 240 via IP network 242. Each client 220 is connected to a different port 250 on access device 230, and determined as being offline when a shutdown status is detected on the respective port 250 (port monitoring is generally indicated at 260).
FIG. 4 and FIG. 5 illustrate IP address recovery in a network 400 in which DHCP relay device 410 is directly connected to DHCP clients 420-1 to 420-4 in examples of the present disclosure. Note that DHCP clients 420-1 to 420-4 are collectively referred to as “clients 420” or individually as a generic “client 420”. Relay device 410 serves as an access device for clients 420 and connects them to DHCP server 440 via IP network 442. Each client 420 is connected to a different port 450 on relay device 410, and determined as being offline when a shutdown status is detected on the respective port 450 (port monitoring is generally indicated at 460).

In the example in FIG. 2, it should be understood that clients 220 are each connected to a different port 250 on access device 230. For example, client 220-1 may be connected to port 250-1, client 220-2 to port 250-2 and client 220-3 to port 250-3 on access device 230-1 (ports 250-1 to 250-3 not shown for simplicity).

When a shutdown status is detected on port 250-2, client 220-2 may be determined as offline. Similarly in FIG. 4, clients 420 are each connected to a different port 450 on relay device 410. For example, client 420-1 is connected to port 450-1, client 420-2 to port 450-2, and so on. When a shutdown status is detected on the port 450-1 to which client 420-1 is connected, client 420-1 may be determined as being offline. Examples in FIG. 2 to FIG. 4 will be described in more detail below.

Any suitable approach for IP address acquisition may be used in network 200 in FIG. 2 and network 400 in FIG. 4. For example, there are generally four stages in the IP address acquisition process: (1) discovery, (2) allocation, (3) selection and (4) confirmation. During (1) discovery, DHCP client 220/420 searches for DHCP server 240/440 by broadcasting a DHCP discover message. During (2) allocation, DHCP server 240/440 responds to DHCP client 220/420 with a DHCP offer message carrying an IP address selected for the client 220/420 together with any other parameters.

Next, during (3) selection, DHCP client 220/420 broadcasts a DHCP request message which contains the IP address offered. If there are multiple DHCP servers 240/440 (one shown in FIG. 2 and FIG. 4 for simplicity) sending offer messages, DHCP client 220/420 may select one IP address (e.g., the first IP address received, etc.) during this stage. Finally, during (4) confirmation, DHCP server 240/440 selected by DHCP client 220/420 confirms allocation of the IP address in the request message by sending a DHCP ACK message to DHCP client 220/420. Otherwise, if the IP address cannot be allocated to DHCP client 220/420, a DHCP NAK message is sent.

DHCP messages may be broadcasted during the IP address acquisition process. In the examples in FIG. 2 and FIG. 4, DHCP server 240/440 and DHCP clients 220/420 do not belong to the same network segment and rely on DHCP relay device 210/410 to connect them. Messages between DHCP clients 220/420 and DHCP server 240/440 are sent via DHCP relay device 210/410, which functions as a gateway for DHCP clients 220/420.

For example, when DHCP relay device 210/410 receives DHCP discover and request messages broadcasted by DHCP clients 220/420, it fills a gateway IP address field (e.g. giaddr) in the messages with the IP address of DHCP relay device 210/410. The messages are then sent to the designated DHCP server 240/440 by way of unicast. DHCP server 240/440 allocates parameters such as an IP address and forwards the configuration information to DHCP client 220/420 via DHCP relay device 210/410. Although an example IP address acquisition approach is described here, other suitable approach may be used.

Client-Access Device-Relay Device

Referring to the examples in FIG. 2 and FIG. 3, IP address recovery in a network where relay device 210 is connected to client 220 via access device 230 may be performed as follows.

At 302 and 304 in FIG. 3, relay device 210 and access device 230 are enabled with an EAIS function of CFD to register port shutdown events respectively. For example, a CFD module on access device 230 may be used to monitor port status. When a shutdown event occurs on the port 250, access device 230 sends an EAIS message to relay device 210 as a fault alarm, to which relay device 210 responds with an EAIS message to suppress the report of fault alarm. When the port 250 is up again, sending of EAIS messages by access device 230 will be stopped.

At 306 in FIG. 3, access device 230 stores MAC address information of client 220. For example, when access device 230 discovers aging of a local MAC address table entry, the aged out table entry is maintained such that access device 230 is able to determine MAC address of an offline client 220 although its corresponding MAC address table entry has already been aged out of the MAC address table. Here, MAC address table refers to a table that stores information generally used for layer 2 message forwarding. Aged out table entries may be stored in any suitable forms, such as in a duplicate local MAC address table. The duplicate local MAC address table (initially empty) may be created when access device 230 is started, or when the first entry is added.

At 310 in FIG. 3 (related to 110 in FIG. 1), relay device 210 stores MAC address and IP address of client 220. For example, when a new entry is added to a local ARP table, MAC address and IP address of client 220 are stored in a DHCP client IP address table (provided the addresses are not previously stored). Any other suitable technique may be used, such as DHCP snooping.

At 322 to 328 in FIG. 3 (related to 120 in FIG. 2), relay device 210 determines whether client 220 is offline. In particular, when a shutdown status is detected on port 250 on access device 230 to which client 220 is connected, client 220 is determined as being offline based on a message sent by access device 230.
At 322, access device 230 monitors, in real time, status of port 250 to which client 220 is connected.
At 324, when a port shutdown status is detected, access device 230 determines the MAC address associated with an identifier of the port 250 (e.g. port number etc.). Access device 230 may rely on a local MAC address table as well as the duplicate MAC address table with aged out entries (see 306 again). For example, access device 230 may first search the local MAC address table for a MAC address that corresponds to the port identifier. If not found, access device 230 may then search the duplicate MAC address table. The MAC address associated with the port 250 having a shutdown status is the MAC address of the offline client. Once found, the corresponding entry will be removed from the relevant table.
At 326, access device 230 sends a message carrying the MAC address to relay device 210. For example, the message includes an extended Type Length Value (TLV) field that carries the MAC address in the message. The value of the “Type” field should be a unique value to identify the field type as the MAC address of the offline client 220. The value of the “Length” field is the length of the MAC address, e.g. 6 bytes. The value of the “Value” field is the value of the MAC address.
At 328, relay device 210 receives the message and determines client 220 having the MAC address in the message as being offline. For example, the extended TLV field in the message is parsed to obtain the MAC address. If EAIS is used, relay device 210 responds to access device 230 by sending an EAIS message via the receiving port. This is to suppress further EAIS messages from access device 230.

At 330 in FIG. 3 (related to 130 in FIG. 1), relay device 210 determines the IP address of client 220 based on the MAC address acquired at 328. For example, the DHCP client IP address table may be searched to identify the IP address based on the MAC address.

At 340 in FIG. 3 (related to 140 in FIG. 1), relay device 210 sends a DHCP release message carrying the IP address to server 240. For example, the message may be sent by way of unicast. After sending the release message, relay device 210 may remove the corresponding entry from the local DHCP client IP address table.

At 350 in FIG. 3, server 240 receives the DHCP release message, parses the message to determine the client's IP address before releasing the IP address such that it is now available for allocation.

Although EAIS is discussed above, it will be appreciated that any other suitable techniques for port monitoring may be used. In that case, it is not necessary to enable EAIS or include a CFD module on relay device 210 and access device 230 at 302 and 304 in FIG. 3.

Also, at 326 in FIG. 3, the message carrying the MAC address of client 220 may be sent using any suitable protocols, such as Link Layer Discovery Protocol (LLDP) etc. After assembling the extended TLV field containing the MAC address of client 220, access device 230 sends an LLDP message that includes the extended TLV field to relay device 210. It should be noted that if an older version of LLDP is used, it may not support transmission of the LLDP message through intermediate devices. However, using a newer version of LLDP, devices between relay device 210 and access device 230 may be pre-configured as service bridges, so that relay device 210 and access device 230 may communicate via LLDP Nearest Customer Bridge message.

Client-Relay Device

Referring now to the examples in FIG. 4 and FIG. 5 (i.e. networking mode of client-relay device-server), IP address recovery in a network where client 420 is connected on port 450 on relay device 410 may be performed as follows. Compared with the examples in FIG. 2 and FIG. 3, an access device is not required to connect relay device 410 to client 420 in FIG. 4 and FIG. 5.

At 502 in FIG. 5, if CFD is used for port monitoring, relay device 410 is enabled with an EAIS function of CFD to register port shutdown events.

At 504 in FIG. 5, when relay device 410 discovers aging of a local MAC address table entry, relay device 410 adds the entry into a locally created duplicate MAC address table with aged out entries. This aged out table entry is stored such that when there is a shutdown event, relay device 410 is able to determine MAC address of a client 420 although its corresponding MAC address table entry is already aged out of the MAC address table. The duplicate MAC address table, which is initially empty, may be created when relay device 410 is started or when the first entry is created.

At 510 in FIG. 5 (related to 110 in FIG. 1), relay device 410 stores MAC address and IP address of client 420. For example, when a new entry associated to client 420 is added to a local ARP table, MAC address and IP address of client 420 are stored in a DHCP client IP address table (provided the addresses are not previously stored). Since relay device 410 usually functions as a gateway for clients 420, MAC and IP addresses of all clients 420 will be eventually stored as new ARP entries are created. The DHCP client IP address table, which is initially empty, may be created when relay device 410 is started or when the first entry is created. Alternatively or additionally, DHCP snooping may be used to store the MAC and IP addresses.

At 522 and 524 in FIG. 5 (related to 120 in FIG. 1), relay device 410 determines whether client 420 is offline based on a shutdown status of port 450 to which client 420 is connected.
At 522, relay device 410 monitors status of port 450 to which client 420 is connected in real time. Any suitable port monitoring techniques may be used, such as using a CFD module to monitor port status in real time etc.
At 524, when a port shutdown status is detected, relay device 410 determines the MAC address associated with an identifier (e.g. port number etc.) of the port 450 to which client 420 is connected. For example, relay device 410 may search a local MAC address table or duplicate MAC address table (see 504 again). The local MAC address table may first be searched. If no corresponding MAC address is found, relay device 410 may then search its duplicate local MAC address table which includes aged out MAC address entries. The MAC address associated with the port 450 having a shutdown status is the MAC address of the offline client.

At 530 in FIG. 5 (related to 130 in FIG. 1), relay device 410 determines the IP address of the offline client 420 based on the MAC address found at 524. For example, the DHCP IP address table may be searched to identify the IP address that corresponds to the MAC address of client 420.

At 540 in FIG. 5 (related to 140 in FIG. 1), relay device 410 sends a DHCP release message carrying the IP address of offline client 420 to server 440. For example, the message may be sent by way of unicast. After sending the release message, relay device 410 may remove the corresponding entry from the local DHCP client IP address table.

At 550 in FIG. 5, server 440 receives the DHCP release message, parses the message to determine the client's IP address before releasing the IP address such that it is now available for allocation.

Example Network Devices 600

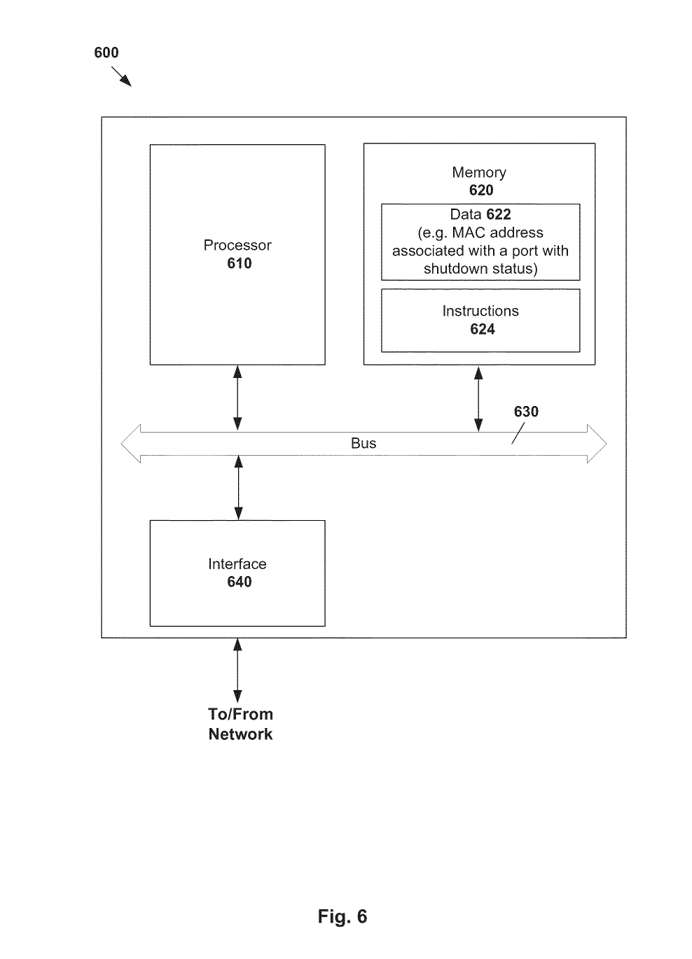

The above examples can be implemented by hardware, software or firmware or a combination thereof. FIG. 6 shows a network device 600 capable of acting as relay device 210/410 or access device 230 in examples of the present disclosure.

Network device 600 includes processor 610, memory 620 and network interface 640 (e.g. port) that communicate with each other via bus 630. Processor 610 is to perform processes described herein with reference to FIG. 1 to FIG. 5.

Relay Device 210/410

In one example, when acting as relay device 210/410, processor 610 is to perform the following for recovering an IP address allocated to a client using DHCP:
Store MAC address and IP address of the client.
When the client is determined as being offline, determine the MAC address of the client, determine the IP address of the client based on the MAC address and send a DHCP release message carrying the IP address of the client to an address allocation server.
The client is determined as being offline based on a shutdown status of a port to which the client is connected. The port may be on the relay device or an intermediate device that connects the client and the relay device.

When network device 600 is acting as access device 230, memory 620 may store any necessary data 622 for facilitating implementation of processes performed by relay device 210/410, such as MAC and IP addresses of clients 220/420 to determine whether they are offline based on a port shutdown event. For example, MAC address table, duplicate MAC address table with aged out entries and client IP address table may be stored.

Memory 620 may further store instructions 624 (not shown in FIG. 6 for simplicity) executable by processor 610, such as:
Instructions to store MAC address and IP address of the client.
Instructions to, when the client is determined as being offline, determine the MAC address of the client, determine the IP address of the client based on the MAC address and send a DHCP release message carrying the IP address of the client to an address allocation server.
The client is determined as being offline based on a shutdown status of a port to which the client is connected. The port may be on the relay device or an intermediate device that connects the client and the relay device.

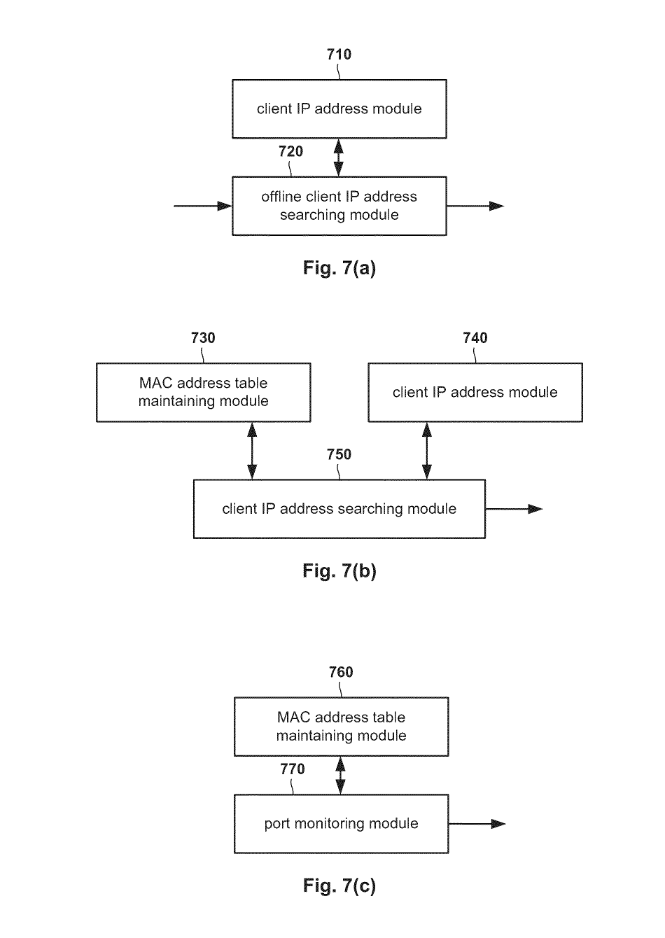

Alternatively or additionally, the example network device 600 in FIG. 6 may include modules (which may be software, hardware or a combination of both) to perform the processes described with reference to FIG. 1 to FIG. 5. FIG. 7(a) shows modules of relay device 210 in FIG. 2 and FIG. 3 in examples of the present disclosure:
Client IP address module 710 (or “client IP address cache module”) is to store a MAC address and an IP address of the client. For example, when an ARP table entry associated with the client is newly created locally, client IP address module 710 is further to store the MAC address and IP address in a client IP address table.
Client IP address searching module 720 (or “offline client IP address searching module”) is to, when the client is determined as being offline, determine the MAC address of the client, determine the IP address of the client based on the MAC address and send a DHCP release message carrying the IP address of the client to an address allocation server.
The client is determined as being offline based on a shutdown status of a port to which the client is connected, the port being on the relay device or an intermediate device that connects the client and the relay device.

In one example, client IP address searching module 720 may include a CFD module to receive an EAIS message from access device 230 when a shutdown status is detected on a port 250 to which client 220 is connected, indicating that the client 220 is offline. The CFD module (not shown for simplicity) may respond to access device 230 with an EAIS message. Client IP address searching module 720 may further include a searching and processing module (not shown for simplicity) to search for the IP address of offline client 220 based on the received MAC address.

FIG. 7(b) shows modules of relay device 410 in FIG. 4 and FIG. 5 in examples of the present disclosure:
MAC address table maintaining module 730 is to store MAC address of clients 420. For example, when discovering aging of a local MAC address table entry, the entry is stored in a duplicate MAC address table with aged out entries.
Client IP address module 740 is to store MAC address and IP address of client 420. For example, when discovering that an ARP table entry associated with the client is newly added locally, client IP address module 760 is to add the new entry into a DHCP client IP address table.
Client IP address searching module 750 is to monitor status of ports 450 on relay device 410 to which clients 420 are connected. When port 450 is detected to have a shutdown status, client IP address searching module 770 is to determine MAC address and IP address of the client 420. For example, the MAC address may be searched (e.g. in local MAC address table or duplicate MAC address table with aged out entries) based on an identifier of port 450. The IP address may be searched in the DHCP client IP address table based on the MAC address associated with port 450.

Access Device 230

Referring to the example network device 600 in FIG. 6 again, when acting as access device 230 in the example network 200 in FIG. 2, processor 610 is to perform the following:
Monitor status of a port to which the client is connected.
Once a shutdown status of the port is detected, determine the client as being offline, determine the MAC address of the client based on an identifier of the port and send a message carrying the MAC address of the client to the relay device.

Memory 620 may store any necessary data 622 for facilitating implementation of processes performed by relay device 210/410, such as MAC addresses of clients 220 to determine whether they are offline based on a port shutdown event. For example, MAC address table and duplicate MAC address table with aged out entries may be stored.

Memory 620 may further store instructions 624 (not shown in FIG. 6 for simplicity) executable by processor 610, such as:
Instructions to monitor status of a port to which the client is connected.
Instructions to, once a shutdown status of the port is detected, determine the client as being offline, determine the MAC address of the client based on an identifier of the port and send a message carrying the MAC address of the client to the relay device.

Alternatively or additionally, the example network device 600 in FIG. 6 may include modules (which may be software, hardware or a combination of both) to perform the processes described with reference to FIG. 1 to FIG. 5. FIG. 7(c) shows modules of a network device capable of acting access device 230 in FIG. 2 and FIG. 3 in examples of the present disclosure:
MAC address table maintaining module 760 is to store MAC address information of clients 220. For example, MAC addresses may be stored in a MAC address table or duplicate MAC address table with aged out entries. Upon discovering aging of a MAC address table entry, module 730 is to record the table entry into the duplicate MAC address table.
Port monitoring module 770 is to monitor status of a port 250 to which a client 220 is connected. When a shutdown status of port 250 is detected, port monitoring module 740 is to determine MAC address of client 220 connected to port 250 and send a message carrying the MAC address to relay device 210.
Port monitoring module 770 is further to determine the MAC address of client 220 by searching the MAC address table or duplicate MAC address table. Once the MAC address is found based on an identifier of the port, the corresponding table entry is removed from the duplicate MAC address table.

In one example, port monitoring module 770 is further for packaging the offline client's 220 MAC address into an extended TLV field of an EAIS message. The extended TLV carries the MAC address of client 220 to allow relay device 210 to determine that client 220 is offline.

The methods, processes and units described herein may be implemented by hardware (including hardware logic circuitry), software or firmware or a combination thereof. The term “processor” is to be interpreted broadly to include a processing unit, ASIC, logic unit, or programmable gate array etc. The processes, methods and functional units may all be performed by the one or more processors 610; reference in this disclosure or the claims to a “processor” should thus be interpreted to mean “one or more processors”.

Although one interface or “network interface device” 640 is shown in FIG. 6, processes performed by the network interface device 640 may be split among multiple network interface devices (not shown for simplicity). As such, reference in this disclosure to a “network interface device” should be interpreted to mean “one or more network interface devices”.

Further, the processes, methods and functional units described in this disclosure may be implemented in the form of a computer software product. The computer software product is stored in a storage medium and comprises a plurality of instructions for making a processor to implement the methods recited in the examples of the present disclosure.

The figures are only illustrations of an example, wherein the units or procedure shown in the figures are not necessarily essential for implementing the present disclosure. Those skilled in the art will understand that the units in the device in the example can be arranged in the device in the examples as described, or can be alternatively located in one or more devices different from that in the examples. The units in the examples described can be combined into one module or further divided into a plurality of sub-units.

Although the flowcharts described show a specific order of execution, the order of execution may differ from that which is depicted. For example, the order of execution of two or more blocks may be changed relative to the order shown. Also, two or more blocks shown in succession may be executed concurrently or with partial concurrence. All such variations are within the scope of the present disclosure.

Throughout the present disclosure, the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

It will be appreciated by persons skilled in the art that numerous variations or modifications may be made to the above-described embodiments, without departing from the broad general scope of the present disclosure. The present embodiments are, therefore, to be considered in all respects as illustrative and not restrictive.

1. A method for recovering an Internet Protocol (IP) address allocated to a client using Dynamic Host Configuration Protocol (DHCP), the method comprising a relay device:
storing a Media Access Control (MAC) address and the IP address of the client; and
when the client is determined as being offline, determining the MAC address of the client, determining the IP address of the client based on the MAC address, and sending a DHCP release message carrying the IP address of the client to an address allocation server,
wherein the client is determined as being offline based on a shutdown status of a port to which the client is connected, the port being on the relay device or an access device that connects the client and the relay device.

2. The method of claim 1, wherein storing the MAC address and the IP address of the client comprises:
when an Address Resolution Protocol (ARP) table entry associated with the client is newly created locally, storing the MAC address and IP address in the ARP table entry in a client IP address table.

3. The method of claim 1, wherein determining the MAC address of the client comprises:
when the client is connected to the port on the access device, receiving the MAC address of the client from the access device after the shutdown status of the port is detected by the access device.

4. The method of claim 3, wherein when an Ethernet Alarm Indication Signal (EAIS) function of Connectivity Fault Detection (CFD) is enabled on the relay device and access device, determining the MAC address of the client further comprises:
receiving the MAC address of the client via an EAIS message from the access device, wherein an extended Type Length Value (TLV) field of the EAIS message carries the MAC address of the client; and
in response to the received EAIS message, returning an EAIS message to the access device.

5. The method of claim 3, wherein when the relay device is directly connected to the access device or indirectly connected to the access device via a service bridge, determining the MAC address of the client further comprises:
receiving the MAC address of the client via a Link Layer Discovery Protocol (LLDP) message from the access device, wherein an extended Type Length Value (TLV) field of the LLDP message carries the MAC address of the client.

6. The method of claim 1, wherein when the client is directly connected to the relay device, determining the MAC address of the client determined as being offline comprises:
monitoring status of the port to which the client is connected; and
once the shutdown status of the port is detected, determining the client as being offline and determining the MAC address of the client based on an identifier of the port.

7. The method of claim 6, wherein the MAC address of the client is determined using a local MAC address table or duplicate MAC address table storing aged out MAC address entries.

8. A network device for recovering an Internet Protocol (IP) address allocated to a client using Dynamic Host Configuration Protocol (DHCP), the network device being capable of acting as a relay device and comprising interface to communicate with an address allocation server, memory storing executable instructions, and a processor to execute instructions to:
store a Media Access Control (MAC) address and the IP address of the client; and
when the client is determined as being offline, determine the MAC address of the client, determine the IP address of the client based on the MAC address, and send a DHCP release message carrying the IP address of the client to an address allocation server,
wherein the client is determined as being offline based on a shutdown status of a port to which the client is connected, the port being on the relay device or an access device that connects the client and the relay device.

9. The network device of claim 8, wherein when storing the MAC address and the IP address of the client, the processor is to:
when an Address Resolution Protocol (ARP) table entry associated with the client is newly created locally, store the MAC address and IP address in the ARP table entry in a client IP address table.

10. The network device of claim 8, wherein when determining the MAC address of the client and the client is connected to the port on the access device, the processor is to:
receive the MAC address of the client from the access device after the shutdown status of the port is detected by the access device.

11. The network device of claim 10, wherein an Ethernet Alarm Indication Signal (EAIS) function of Connectivity Fault Detection (CFD) is enabled on the relay device and access device, and when determining the MAC address of the client, the processor is to:
receive the MAC address of the client via an EAIS message from the access device, wherein an extended Type Length Value (TLV) field of the EAIS message carries the MAC address of the client; and
in response to the received EAIS message, return an EAIS message to the access device.

12. The network device of claim 10, wherein the relay device is directly connected to the access device or indirectly connected to the access device via a service bridge, and when determining the MAC address of the client, the processor is to:
receive the MAC address of the client via a Link Layer Discovery Protocol (LLDP) message from the access device, wherein an extended Type Length Value (TLV) field of the LLDP message carries the MAC address of the client.

13. The network device of claim 8, wherein the client is directly connected to the relay device, and when determining the MAC address of the client, the processor is to:
monitor status of the port to which the client is connected; and
once the shutdown status of the port is detected, determine the client as being offline and determining the MAC address of the client based on an identifier of the port.

14. A network device for recovering an Internet Protocol (IP) address allocated to a client using Dynamic Host Configuration Protocol (DHCP), the network device being capable of acting as an access device and comprising memory storing executable instructions, interface to communicate with a relay device and the client, and a processor to execute instructions to:
monitor status of a port to which the client is connected; and
once a shutdown status of the port is detected, determine the client as being offline, determine the MAC address of the client based on an identifier of the port, and send a message carrying the MAC address of the client to the relay device.

15. The network device of claim 14, wherein when an Ethernet Alarm Indication Signal (EAIS) function of Connectivity Fault Detection (CFD) is enabled on the relay device and access device, and the message carrying the MAC address of the client is an EAIS message and an extended Type Length Value (TLV) field of the EAIS message carries the MAC address of the client.
